(19) United States
(12) Patent Application Publication
(10) Pub. No.: US 2017/0001213 A1
(43) Pub. Date: Jan. 5, 2017

(54) IRRIGATION RISER SUPPORT STAKE

(71) Applicant: RANDALL PETERSON, JEROME, ID (US)

(72) Inventor: RANDALL PETERSON, JEROME, ID (US)

(21) Appl. No.: 14/850,335

(22) Filed: Sep. 10, 2015

Related U.S. Application Data
(60) Provisional application No. 62/187,676, filed on Jul. 1, 2015.

(51) Int. Cl. B05B 15/06; B05B 15/10; A01G 25/00

(52) U.S. Cl. CPC B05B 15/062; A01G 25/00; B05B 15/10

(57) ABSTRACT

A support stake for irrigation risers. Disclosed is a support stake which is configured for setting into the ground and which has a bracket which immobilizes the irrigation riser. The support stake resists the rotation of the irrigation riser around the irrigation pipe to which the riser is attached. The irrigation riser typically has an impact sprinkler on it which delivers a force which causes the irrigation riser to rotate in one direction and not the other. This stake prevents that rotation by trapping the riser in the bracket, and by being anchored in the ground.

### PRIORITY/CROSS-REFERENCE TO RELATED APPLICATIONS

This application claims the benefit of U.S. Provisional Application No. 62/187,676, filed Jul. 1, 2015 the disclosure of which is incorporated by reference.

### TECHNICAL FIELD

The presently disclosed technology relates to irrigation tools, and more specifically to support structures for stabilizing irrigation risers.

### BACKGROUND

A common way to irrigate fields is by use of impact sprinkler heads mounting on short riser pipes, with the risers attached to a larger pipe which carries water. Because the impact sprinkler heads interrupt the flow of water at regular intervals as the head rotates, some force is applied to the risers. The riser is typically braced so that the force of the sprinkler head does not force the riser to move away from a vertical position.

A common way to stabilize the sprinkler riser is to use two wooden stakes, such as wooden lathe stakes. These are placed on opposite sides of the irrigation pipe, next to the riser, and place at an angle so that the stakes cross each other at the riser. The two stakes are typically joined to each other with a piece of wire to secure the riser to them, and thus keep the riser in a vertical position. This technique is time consuming, and it is easy to lose the wooden stakes, and the wire piece. This can result in pieces of wire and wooden stakes getting in harvesting machinery later in the season.

### SUMMARY OF THE DISCLOSURE

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the inventive concept(s) of the application, which is measured by the claims, nor is it intended to be limiting as to the scope of the inventive concept(s) in any way.

The disclosed technology is a support stake for an irrigation riser. The referenced irrigation riser is a pipe which extends vertically from a larger irrigation pipe which lays on the ground. The irrigation riser has a sprinkler head attached to the top of it, typically an impact type sprinkler head, which in operation produces a lot of vibration and tends to move the riser pipe. A riser does not move away from being perpendicular to the long axis of the irrigation pipe, but it can rotate around the long axis of the pipe, and thus the irrigation riser can move off of its vertical position into some other angle less than vertical. The support stake of the disclosed device prevents that by bracing against the impact of the impact sprinkler head.

The disclosed support stake includes a stake body which is flat and elongate and is pointed at one end, the first end. It has at least one reinforcing rib which is attached to the stake body parallel with the long axis of the stake body. It can have one support rib, which makes the support stake have a generally T-shaped cross-section. It can also have two support ribs, making the support stake have a generally cross shaped cross-section. It can also be round and tubular, and also with an X or radial three bladed cross section. The stake body has a first end and a second end. The first end is pointed and is configured for penetration into the ground. The second end of the stake body has a flat area which is for use in pushing the stake body into the ground. For this purpose the user's foot may be used or a hammer of some kind may be used to push the stake body into the ground.

The support riser also has an extension piece which can be either attached somewhere towards the top of the stake body, or at the very top of the stake body, adjacent to the foot pad. The extension piece extends at an angle from the stake body and has attached to it a U-shaped bracket which is placed with the irrigation riser between the side pieces of the U-shaped bracket. The U-shaped bracket can be semi-circular in shape, and can be sized to snap into place around a round irrigation riser. The U-shaped bracket can also be formed of three flat pieces, the two side walls and the base of the bracket. These would be placed on either side of the irrigation riser to prevent the irrigation riser from rotating away from vertical above the underlying irrigation pipe.

The riser support stake can also have a carrying loop defined in either the stake body or the extension piece, which is a loop of material which allows the support stake to be carried more easily on a carrying rack. The carrying rack can include a projecting rod which is inserted into the carrying loop of the support stake, so that a person can carry a number of support stakes on the carrying rod.

The extension piece can also include an adjustment slot, with the U-shaped bracket attached in the adjustment slot. The U-shaped bracket in this configuration would be slidable along the U-shaped slot and lockable into place anywhere along the travel of the slot. It can be lockable by a wing nut or by other tightening means so that the U-shaped bracket can be adjusted in position to fit a particular irrigation riser.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a perspective view of the disclosed riser support stake.

FIG. 2 is a top view of the disclosed riser support stake.

FIG. 3 is a top view of a round cross section bracket.

FIG. 4 is a perspective view of the disclosed riser support stake.

FIG. 5 is a side view of the disclosed riser support stake.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

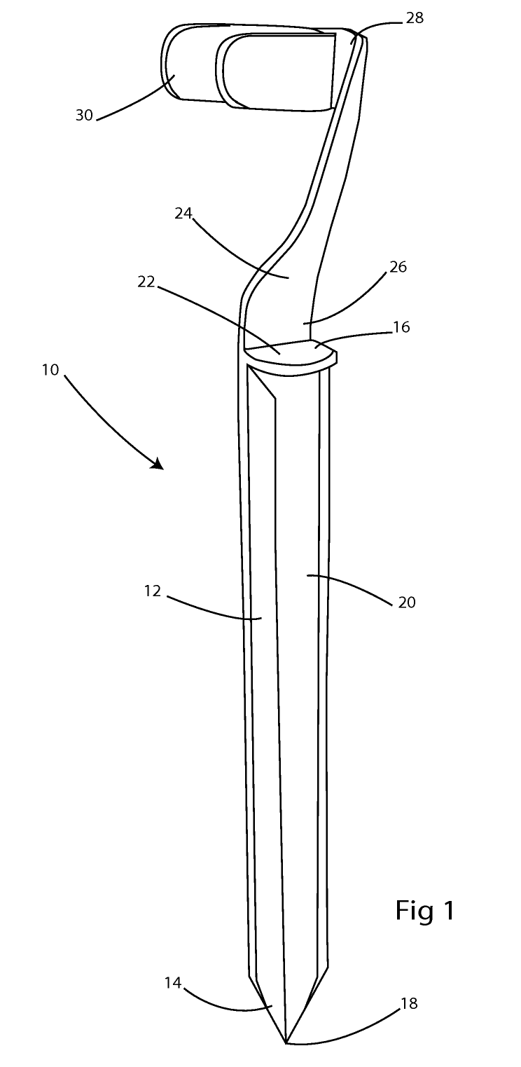

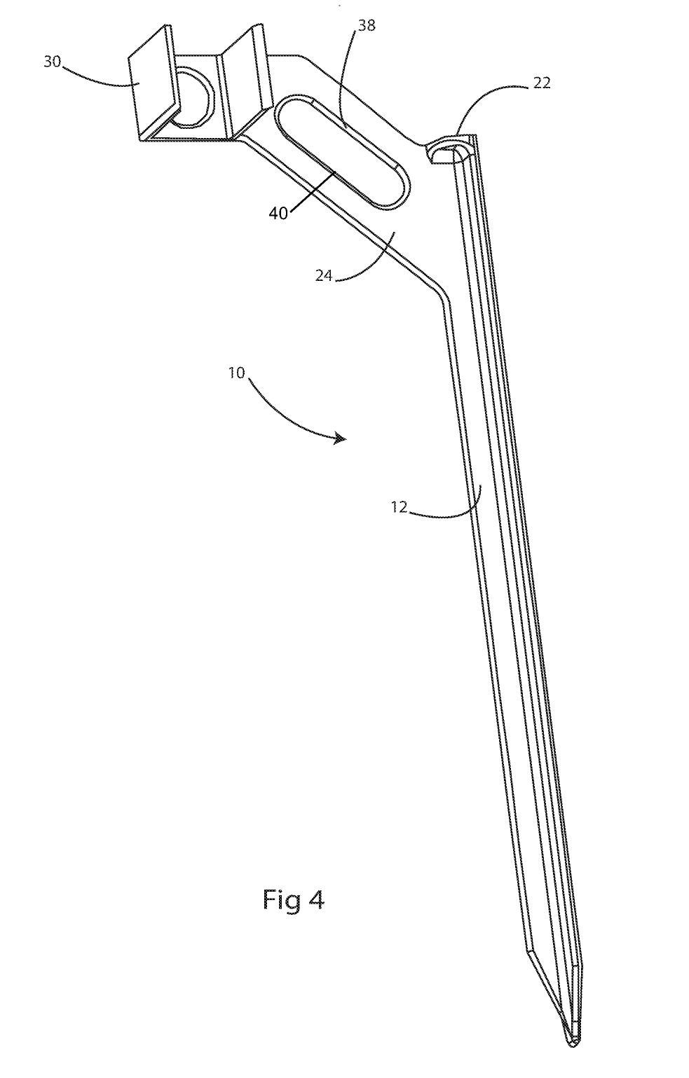

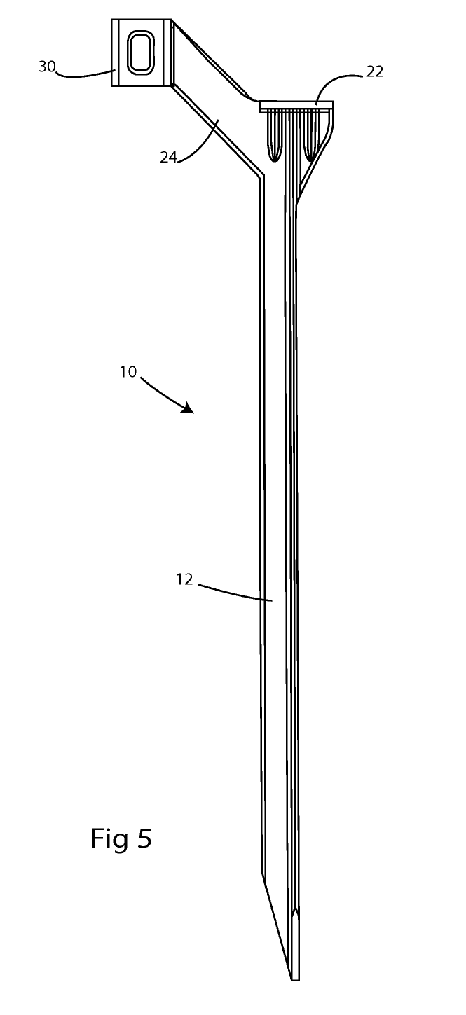

Shown in FIG. 1 is a perspective view of the irrigation riser support stake of the present invention. The support stake is structured for being pounded or pressed into the ground, and for resisting the rotation of a support riser on an irrigation pipe. The support stake 10 includes a stake body 12 which is an elongate shaft with a first end 14 and a second end 16. The first end forms a point 18 for penetration into the soil. The stake body 12 has one or more support ribs 20 attached along the long axis of the stake, for reinforcement. Positioned at the second end 16 of the stake body 12 is a foot pad 22 which can be used by placing a foot on the foot pad 22 and pressing the stake body 12 into the ground. Alternatively, the foot pad can be used as a position for hammering the support stake 10 into the ground. Attached at the second end 16 of the stake body 12 is an extension piece 24. The extension piece 24 extends above the foot pad and has a first end 26 attached to the stake body and a second end 28 which is attached to a bracket 30. The extension piece and bracket can take a number of shapes, with a preferred one shown in FIG. 1. In the example of FIG. 1, the bracket 30 is generally U shaped when seen from the top. The extension piece 24 can be generally vertical from the foot pad 24, as shown in FIG. 1, as long as the foot pad 24 is accessible for pushing the riser support stake into the ground. The extension piece 24 can also be at an angle such as 45 degrees from the stake body 12, as shown in FIGS. 4 and 5. The food pad 22 can be broader or narrower, as shown in FIGS. 4 and 5.

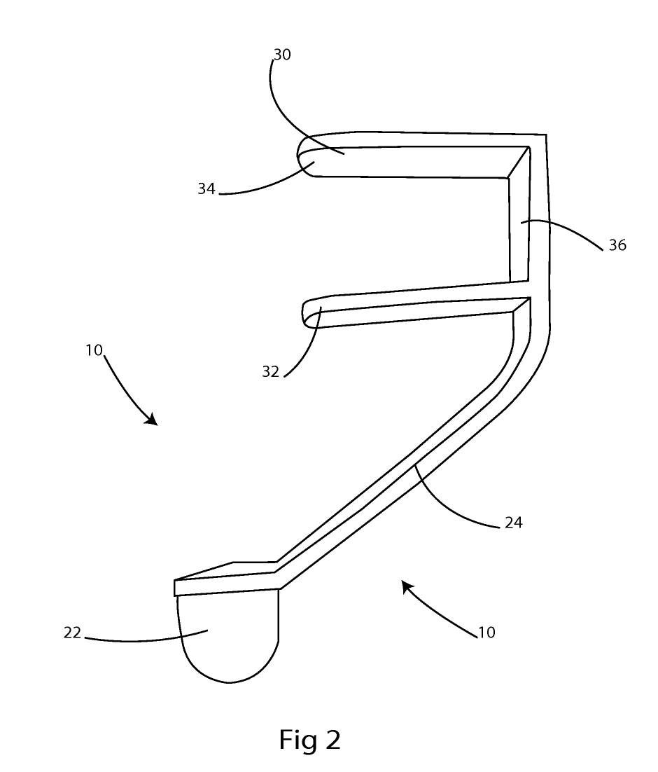

FIG. 2 shows the support stake 10 as in FIG. 1, viewed from the top. Shown is the foot pad 22, the extension piece 24, and the bracket 30 which in this case is U shaped with a first bracket side 32 and a second bracket side 34 and a bracket back side 36.

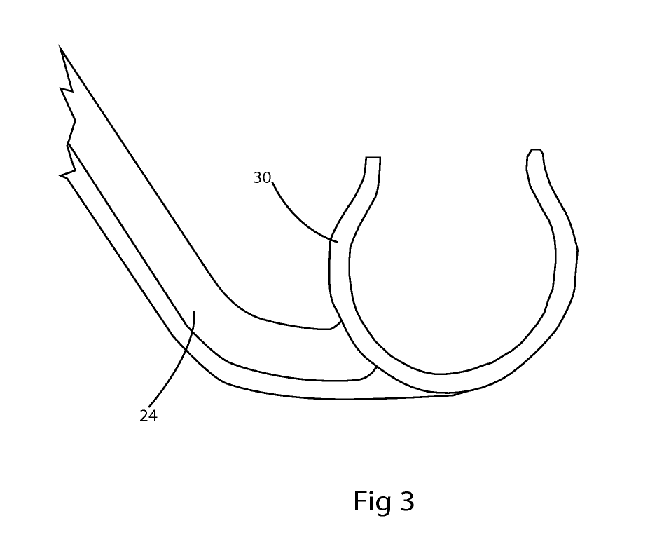

Shown in FIG. 3 is the bracket 30 showing an alternative shape to the bracket, which is attached to the extension piece 24. In this case the stake body is not shown. The design in FIG. 3 functions the same way as the design in FIGS. 1 and 2, but is a semi-circular shape in cross section, and snaps around the round tube of the irrigation riser.

FIG. 4 shows an irrigation support stake with the same features as discussed above, namely the stake body 12, the extension piece 24, the bracket 30, and the foot pad 22.

It also has a carrying loop 38 defined in the extension piece 24, which can be used to carry multiple stakes on a rod or loop held by a user or attached to his belt.

FIG. 5 is a side view of a slightly different of the support stake, showing the stake body 12, the extension piece 24, the bracket 30, and the foot pad 22.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1. An irrigation riser support stake, for stabilizing an irrigation riser with an attached sprinkler head from rotation around a water pipe, said riser support stake comprising
a stake body, comprising a planar and elongate shaft with a first end and a second end, with said first end forming a point for soil penetration, and with said shaft having one or more support ribs attached along the long axis;
a foot pad at the second end of said stake body, configured for pushing or hammering said riser support stake by a user into the soil;
an extension piece attached at an angle to the stake body at the second end of said stake body, said extension piece having a first end attached to said stake body, and a second end attached to a bracket formed from two flat side pieces and a flat bottom portion, which form a U when seen from the second end of said stake body, with said bracket configured for limiting movement of said riser in at least two directions.

2. The riser support stake of claim 1 in which said bracket forms a partial circle in cross section, for snapping onto a round riser pipe, to prevent movement of said riser in all directions with said extension piece attached to said stake body at an angle of approximately 45 degrees.

3. (canceled)

4. The riser support stake of claim 1 in which said stake body has a single support rib, and forms a T or Y shape in cross section.

5. The riser support stake of claim 1 in which said riser support stake has a carrying loop defined in said stake body or extension piece, to allow said riser support stake to be carried by said carrying loop.

6. (canceled)

7. The riser support stake of claim 1 in which said extension piece is attached to a mid-point of said stake body.

8. The support stake of claim 1 in which said extension piece defines an adjustment slot, with said u shaped bracket configured for sliding attachment to said adjustment slot.
